(19) United States
(12) Patent Application Publication
(10) Pub. No.: US 2010/0279223 A1
(43) Pub. Date: Nov. 4, 2010

(54) TONER AND METHOD FOR PRODUCING TONER

(75) Inventors: Mikihiko SUKENO, Tokyo (JP); Yasuko UCHINO, Tokyo (JP); Tomomi OSHIBA, Tokyo (JP); Nagayuki UEDA, Tokyo (JP); Makoto KOBAYASHI, Tokyo (JP); Ken OHMURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/769,026

(22) Filed: Apr. 28, 2010

(30) Foreign Application Priority Data
May 1, 2009 (JP) 2009111714

(51) Int. Cl. G03G 9/087; G03G 5/00

(52) U.S. Cl. 430/109.4; 430/137.13

(57) ABSTRACT

Disclosed is a toner including: a toner particle including at least a resin, a coloring agent and a mold release agent, wherein an average value e of degree of circularity of the toner particle is within 0.935=e=0.982, a maximum endothermic peak temperature of the mold release agent exists within 85-98° C., the resin includes at least non-crystalline polyester and crystalline polyester, and a ratio a of multivalent carboxylic acid of trivalent or higher-valent and a ratio c of straight chain aliphatic dial are such that 12.5=a=46, 20=c=65, 0.25=a/c=1.52, the multivalent carboxylic acid of trivalent or higher-valent and/or the straight chain aliphatic dial constituting the non-crystalline polyester and/or the crystalline polyester.

### BACKGROUND

1. Field of the Invention

The present invention relates to a toner and a method for producing the toner.

2. Description of Related Art

Binder resins for a toner which has been put into practical use for electrophotography can be divided roughly into styrene-acrylic resins and polyester resins including modified polyesters. For the polyester resins, there are relatively many options for monomer selection, and there is a lot of flexibility of design of polymer main chain. By designing the main chain, it is possible to reduce micro-Brownian movement of the polymer at ambient temperatures, and to control fusion characteristics of the binder resins.

In order to reduce electric power required for forming a toner image by reducing toner fixing temperature, in addition to improvement of the above-mentioned fusion characteristics of the binder resins, using a mold release agent having a low melting point becomes necessary. As the mold release agent, a paraffin wax, a synthetic ester wax, and the like may be cited, but their polarities are too far from that of conventional polyester resins. For this reason, when using the mold release agent having a low melting point such as the paraffin wax which has low hardness even at ambient temperatures and the synthetic ester wax, sometimes a mold release agent particle secedes from a toner particle and photoreceptor filming occurs due to the mold release agent particle which seceded. In order to avoid such phenomenon, there has been disclosed a technique to cover the mold release agent particles respectively by crystalline polyester resin particles to disperse them in the toner particle (for example, see Japanese Patent Application Laid-open Publication No. 2008-40319).

Since toner particle diameters become non-uniform when using the crystalline polyester resins, it has been tried to uniformize inside or structure configuration of the toner by designing an acid value of the toner to a specific value (for example, see Japanese Patent Application Laid-open Publication No. 2008-233175). In addition, there has been disclosed a toner whose anti-scratch property is improved by combining crystalline polyester resin with non-crystalline polyester resin to reduce fixing temperature and by setting an ester concentration of this crystalline polyester resin to a specific value (for example, see Japanese Patent Application Laid-open Publication No. 2008-203779).

### SUMMARY

Although introducing the crystalline polyester resin is advantageous to reduce fixing temperature for introducing the mold release agent as described above, there has been a problem that glossiness becomes excessive and it becomes difficult to read characters on a sheet due to light reflected from the toner on the sheet.

Moreover, there has been a problem that dispersion of coloring agents becomes non-uniform. Especially, a transfer performance of carbon black having low electric resistance becomes unstable if the carbon blacks are not dispersed in the toner particle uniformly. As a result, sharpness of a toner image and gray-level reproducibility become low. In addition, consumption of the toner increases due to reduction of transfer rate.

The objection of the present invention is to provide a toner by which the fixing temperature reduction is improved, excessive glossiness is reduced, and the sharpness of image and the gray-level reproducibility are improved.

According to one aspect of the present invention, there is provided a toner including: a toner particle including at least a resin, a coloring agent and a mold release agent,

wherein an average value e of degree of circularity of the toner particle is within 0.935≦e≦0.982,

a maximum endothermic peak temperature of the mold release agent exists within 85-98° C.,

the resin includes at least non-crystalline polyester and crystalline polyester, and

a ratio a of multivalent calboxylic acid of trivalent or higher-valent and a ratio c of straight chain aliphatic dial are such that
12.5≦a≦46
20≦c≦65
0.25≦a/c≦1.52,
   the multivalent calboxylic acid of trivalent or higher-valent and/or the straight chain aliphatic dial constituting the non-crystalline polyester and/or the crystalline polyester.

In this regard, however, an ackylene glycol component ether-bonded with polyhydric alcohol component is not included in the ratio c of the straight chain aliphatic dial.

Preferably, the ratio a of the multivalent calboxylic acid of trivalent or higher-valent and the ratio c of the straight chain aliphatic diol are such that
23≦a≦39
20.8≦c≦52.0
0.37≦a/c≦0.80.

According to other aspect of the present invention, there is provided a method for producing a toner including at least a non-crystalline polyester resin, a crystalline polyester resin, a coloring agent and a mold release agent, the method including the steps of:

### (1) Forming a Core Particle by Agglutinating Materials of:

i) a non-crystalline polyester resin particle including the multivalent calboxylic acid of trivalent or higher-valent of 17-30 mol % with respect to all acid monomers;

ii) a crystalline polyester resin particle composed of straight chain aliphatic diol having a carbon number of 4-22 and straight chain aliphatic dicarboxylic acid having a carbon number of 4-22;

iii) a mold release agent particle whose maximum endothermic peak temperature exists within 85-98° C.; and

iv) a coloring agent particle, and

### (2) Adding the Non-Crystalline Polyester Resin Particle to Form a Shell Layer of the Non-Crystalline Polyester Resin to Cover the Core Particle,

provided that a mass ratio between a sum of the non-crystalline polyester resins added in the step (1) and the step (2), and the crystalline polyester resin is within 90:10-60:40.

According to the present invention, since the toner includes the crystalline polyester resin, fixing temperature reduction is improved, and by controlling a copolymerization ratio of the multivalent carboxylic acid of trivalent or higher-valent to control the toner shape to be within a certain range, excessive glossiness of the toner image due to inclusion of the crystalline polyester resin can be reduced. Moreover, by controlling a copolymerization ratio between the multivalent carboxylic acid of trivalent or higher-valent and the straight chain aliphatic diol, dispersion of the coloring agent particle and the mold release agent particle in the toner particle can be improved, and thereby transferring characteristics become good. As a result, sharpness of the toner image and gray-level reproducibility improve.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a table showing a list of monomers used in preparation of dispersion liquids 1-6 of non-crystalline polyester resin;

FIG. 2 is a composition ratio calculating table; and

FIG. 3 is a table showing evaluation results of toners 1-30 of examples and comparative examples.

### DETAILED DESCRIPTION OF THE PREFERRED EMBODIMENT

In the following, a toner according to the present invention and a method for producing the toner will be described.

### <Toner>

The toner of the present invention is composed of a toner particle containing at least polyester resin, a coloring agent, and a mold release agent. An average value e of degree of circularity of the toner particles is such that 0.935≦e≦0.982. A maximum endothermic peak temperature of the mold release agent is within 85-98° C. A ratio a of multivalent calboxylic acid of trivalent or higher-valent and a ratio c of straight chain aliphatic diol are such that 12.5≦a≦46, 20≦c≦65, 0.25≦a/c≦1.52.

In this regard, however, an ackylene glycol component ether-bonded with a polyhydric alcohol component is not included in the ratio c of the straight chain aliphatic diol. The ratio a indicates a ratio (mol %) of the calboxylic acid of trivalent or higher-valent with respect to all acid monomers, and the ratio c indicates a ratio (mol %) of the straight chain aliphatic diol with respect to all alcohol monomers.

The toner of the present invention has a core shell structure, and composed of core particle which is composed of the binder resin, the coloring agent and mold release agent, and a shell layer to cover the core particle.

### 1. Non-Crystalline Polyester Resin

The toner of the present invention contains non-crystalline polyester resin as the binder resin. By containing non-crystalline polyester resin, the dispersion of the coloring agent in the toner particle and anti-filming property of the toner are improved. Incidentally, non-crystalline polyester resin means polyester resin which does not have an endothermic peak in change of an endothermic amount in Differential Scanning Calorimetry (DSC) method.

The non-crystalline polyester resin which may be used in the toner of the present invention is not especially limited as long as it has non-crystalline property, and known polyester resins may be used.

For example, the non-crystalline polyester resin can be obtained by combining known multivalent calboxylic acid and polyhydric alcohol. Commercial non-crystalline polyester resin, or non-crystalline polyester resin obtained by proper combination may be used.

As the polyhydric alcohol component constructing the non-crystalline polyester resin, for example, a dihydric alcohol such as 1,4-butanediols, 2,3-butanediols, diethylene glycols, triethylene glycols, 1,5-pentanediols, 1,6-hexandiols, neopentyl glycols, 1,4-cyclohexanedimethanols, dipropylene glycols, polyethylene glycols, polypropylene glycols, bisphenols A, ethylene oxide adducts of bisphenols A, propylene oxide adducts of bisphenols A, and hydrogenated bisphenols A may be cited. As a trihydric alcohol, for example, glycelenes, sorbitols, 1,4-sorbitans and trimethylolpropanes may be cited.

The multivalent calboxylic acid component constructing the non-crystalline polyester resin is a calboxylic acid of trivalent or higher-valent. As the calboxylic acid of trivalent or higher-valent, trimellitic acids, 1,2,4-benzenetricarboxylic acid, 1,2,5-benzenetricarboxylic acid, 1,2,4-naphthalenetricarboxylic acid, acid anhydrides and lower alkyl ester thereof may be cited. They can be used independently, or two or more kinds of them can be used together.

In addition, a calboxylic acid of lower-valent than trivalent such as aliphatic dicarboxylic acids and aromatic dicarboxylic acids may be used together. As the aliphatic dicarboxylic acids, for example, oxalic acids, succinic acids, glutaric acids, adipic acids, sperin acids, azelaic acids, sebacic acids, 1,9-nonanedicarboxylic acids, 1,10-decanedicarboxylic acids, 1,12-dodecanedicarboxylic acids, 1,14-tetradecanedicarboxylic acid, and 1,18-octadecanedicarboxylic acid may be cited. As the aliphatic dicarboxylic acids, for example, phthalic acids, isophthalic acids, terephthalic acids, naphthalene-2s, 6-dicarboxylic acids, malonic acid, and mesamonine acids may be cited. Also a derivative such as a salt of diprotic acids and acid anhydrides of these carboxylic acids, and lower alkyl esters may be used.

It is preferable that the dicarboxylic acid component constituting the non-crystalline polyester resin includes a dicarboxylic acid component having a sulfonate group in addition to the above-described aliphatic dicarboxylic acid and the aromatic dicarboxylic acid. The dicarboxylic acid component having a sulfonate group effectively contribute to improvement of dispersion of the coloring agent such as pigments. When producing a resin-particles-dispersed liquid by allowing resin particles to be emulsified or suspended and dispersed in an aqueous media, since the dicarboxylic acid component has the sulfonate group, emulsifying or suspending and dispersing become possible without using surface activating agents.

The method for producing the non-crystalline polyester resin is not especially limited, and the non-crystalline polyester resin can be produced by a known method for polymerizing a polyester resin by reacting an acid component with an alcohol component. Specifically, directly polycondensation, interesterification, or the like may be selected as the producing method depending on kinds of monomers. A molar rate between the acid component and the alcohol component when reacting the acid component with the alcohol component is normally 1:1, though the molar ratio is not always same and changes depending on reaction conditions or the like.

It is preferable to set a polymerization temperature to 180-230° C. when the non-crystalline polyester resin is produced, and to reduce a pressure in a reaction system as necessary so that a reaction occurs while water and/or alcohol produced at the time of polymerization are removed from the reaction system. When the monomer is not dissolved or compatibilized under the reaction temperature, it is possible to add a high-boiling solvent as a solubilization agent so as to dissolve such polymer. Incidentally, when performing the polymerization reaction, it is preferable to perform the reaction while distilling away the solubilization agent. When there is the monomer having a poor compatibility in the polymerization reaction, it is preferable to previously react the monomer having the poor compatibility with an acid or alcohol to be reacted with the monomer and then polymerize it with a primary component.

Moreover, it is preferable to perform the polymerization reaction by adding a catalyser when non-crystalline polyester resin is produced. As usable catalyser, a stannum compound, zirconium compound, and germanium compound may be cited. Specifically, tetraphenyltin, dibutyltin dichloride, dibutyltin oxide, diphenyltin oxide, zirconium tetra-butoxide, zirconium naphthenate, zirconyl carbonate, zirconyl acetate, zirconyl stearate, octylic acid zirconyls, germanium oxides, triphenyl phosphites, tris(2,4-di-t-butylphenyl)phosphate, ethyltriphenylphosphonium bromides, triethylamines, and triphenylamines may be cited. It is also possible to use a Lewis acid such as rare-earth metals and dodecylbenzensulphonic acids in order to reduce a discharge amount of carbon dioxide which occurs by performing the production with a lowered polymerization temperature.

### 2. Crystalline Polyester Resin

The toner used in the present invention includes a crystalline polyester resin as a fixing aid. In the present invention, the crystalline polyester resin means a polyester resin which has a clear endothermic peak in Differential Scanning Calorimetry (DSC) method. By including the crystalline polyester resin, fixing temperature reduction can be achieved.

The crystalline polyester resin is not especially limited as long as it has the above-described endothermic peak. For example, when there is a polymer having a configuration where other component is copolymerized to the principal chain of the crystalline polyester resin, if the resin composed of this polymer has the endothermic peak, it corresponds to the crystalline polyester resin of the present invention.

As the aliphatic dicarboxylic acid to form the crystalline polyester resin of the present invention, the aliphatic dicarboxylic acid having a carbon number of 4-22 is used. More preferably, the carbon number is 4-10. As such aliphatic dicarboxylic acid, for example, adipic acids, pimelic acids, suberic acids, azelaic acids, sebacic acids, 1,9-nonanedicarboxylic acids, 1,10-decanedicarboxylic acids, 1,11-undecanedicarboxylic acids, 1,12-dodecanedicarboxylic acids, 1,13-tridecanedicarboxylic acids, 1,14-tetradecanedicarboxylic acid, 1,16-hexadecanedicarboxylic acids, and 1,18-ocradecanedicarboxylic acids may be cited.

It is also possible to produce the crystalline polyester by adding the aromatic dicarboxylic acid to the aliphatic dicarboxylic acid. As the usable aromatic dicarboxylic acid, for example, terephthalic acids, isophthalic acids, and orthophthalic acids are preferable. An additive amount of the aromatic dicarboxylic acid is preferably 20 mol or less with respect to the crystalline polyester, more preferably 10 mol % or less, and further more preferably 5 mol % or less. By allowing the additive amount of the aromatic dicarboxylic acid to be 20 mol % or less, emulsification can be surely performed when producing the crystalline polyester, and crystalline of the polyester resin is ensured. This is preferable for obtaining glossiness peculiar to the crystalline polyester resin. This is also preferable to remove a cause of concern about reduction of image storage stability due to depression of melting point.

Although the straight chain aliphatic diol component is essential for the alcohol component of the crystalline polyester resin, a component such as an aliphatic branched diol component and an alicyclic diol other than the straight chain aliphatic diol component may be contained as long as they are less than 20%. A ratio of the straight chain aliphatic diol corresponding to above-described c to all alcohol monomers preferably derives from the crystalline polyester, but the ratio may be obtained based on a sum of the straight chain aliphatic diol component which derives from the crystalline polyester and the straight chain aliphatic diol component which derives from the non-crystalline polyester. In order to ensure ease of obtaining and certainly of fixing temperature reduction, and to obtain an image having high glossiness, the straight chain aliphatic diol having 2-14 carbon atoms which constitute the principal chain is especially preferable. Though the branch-type aliphatic dial may be used together, it is preferable to allow the ratio of the straight chain aliphatic diol to be relatively high in order to ensure the crystalline of the polyester resin. By allowing the ratio of the straight chain aliphatic diol to be relatively high, the crystalline is ensured, and a problem of the reduction of image storage stability due to depression of melting point can be prevented. This is also effective for stabilization of anti-toner-blocking characteristics and fixing temperature reduction.

The number of carbon atoms constituting the principle chain of the straight chain aliphatic dial is 4-22. By allowing the number to be within this range, the polyester resin having a melting point which prevents the fixing temperature reduction is not formed even when the aromatic dicarboxylic acid is used tighter, and thereby melting is sufficiently performed at the time of low temperature fixing. Preferably, 4-22 carbon number is used, and more preferably 4-10.

As the straight chain aliphatic diol, 1,4-butanediols, 1,5-pentanediols, 1,6-hezanediols, 1,7-heptanediols, 1,8-octanediols, 1,9-nonanediols, 1,10-decanediols, 1,11-undecanediols, 1,12-dodecanediols, 1,13-tridecanediols, 1,14-tetradecanediols, 1,18-octadecanediols, and 1,20-icosanediols may be cited, but it is not limited to the above. Among those, 1,4-butanediols, 1,6-hezanediols, 1,9-nonanediols, and 1,10-decanediols are preferable.

A ratio a of the calboxylic acid of trivalent or higher-valent with respect to all acid monomers of the polyester resin (both of non-crystalline and crystalline) included in the toner is such that 12.5≦a≦46, and preferably 23≦a≦39, in order to keep character images in glossiness to be easily read.

A ratio c of the straight chain aliphatic diol with respect to all alcohol monomers of the polyester resins (both of non-crystalline and crystalline) included in the toner is such that 20≦c≦1.52, and preferably 20.8≦c≦52.0, in order to ensure the fixing temperature reduction and to reduce filming.

A ratio of the ratio a of the calboxylic acid of trivalent or higher-valent to the ratio c of straight chain aliphatic diol is 0.25≦a/c≦1.52, and preferably 0.37≦a/c≦0.80, in order to ensure the fixing temperature reduction and to keep character images in glossiness to be easily read.

Furthermore, an average value e of degree of circularity of the toner particle is set such that 0.935≦e≦0.982 in order to improve transfer performance and sharpness of images, and a maximum endothermic peak temperature of the mold release agents is set to 85-98° C., in order to maintain sharpness of images.

It is generally considered that in the non-crystalline polyester, the carboxylic acid monomer of trivalent or higher-valent functions as a cross-linking agent of resin, and a molecular chain of the resin is arranged to form a net-like structure, while the carboxylic acid monomer is a branching point. The higher the copolymerization ratio of the carboxylic acid monomer of trivalent or higher-valent, the higher the degree of elasticity of the toner. However, also the fixing temperature rises at that time, and as a result, a degree of fixedness is lowered. Thus, there has been a generally-accepted idea that “simultaneously achieving reduction of glossiness and improvement of the degree of fixedness is difficult” among persons skilled in the art. However, the inventors of the subject application found that by making a configuration where the carboxylic acid monomer of trivalent or higher-valent is a branching point, the molecular chain forms a net-like structure, and the monomer having a soft straight-chain configuration is tangled, the degree of elasticity of the toner and the low temperature fixing can be achieved simultaneously. As a result of consideration, the inventors estimate that by setting the ratio of the ratio c of the straight chain aliphatic dial with respect to all alcohol monomers to the ratio a of the carboxylic acid of trivalent or higher-valent with respect to all acid monomers to be within a certain range, the fixing temperature reduction can be achieved while reducing excessive glossiness by increase of the degree of elasticity of the toner. In addition, the inventors estimate that since a domain which the crystalline polyester forms in the toner particle is strongly conjugated to a matrix formed by the non-crystalline polyester, the filming due to separation of the crystalline polyester component is improved.

The fixing temperature reduction can be achieved by introducing the crystalline polyester into the toner, but glossiness easily becomes excessive. According to the present invention, by controlling the copolymerization ratio (ratio a) of the carboxylic acid of trivalent or higher-valent and the degree of circularity to be within a certain range, the excessive glossiness is reduced. The toner image is an image which is formed with toner by development.

Moreover, there has been a problem that dispersion of the coloring agent becomes non-uniform by adding the crystalline polyester resin and thereby transferring characteristics become unstable. With respect to this problem, the present invention allows the core particle to have a shell configuration with the-non-crystalline polyester resin so that the crystalline polyester resin making transferring characteristics unstable is not exposed at a surface of the toner particle. In addition, the present invention allows the carboxylic acid of trivalent or higher-valent to be exposed at the surface of the toner particle with the certain copolymerization ratio, and thereby a concentration of a carboxyl radical at a toner surface becomes uniform. As a result, stable development with decreased voltage can be achieved. It is also estimated that since the multivalent carboxylic acid as a polarity unit of the toner maintains the coloring agent inside the toner, and since the straight chain aliphatic diol as a non-polarity unit of the toner maintains the mold release agent inside the toner, the coloring agent particle and the mold release agent particle are dispersed uniformly in the toner particle, and thereby the transferring characteristics become good. As a result of improvement of an amount of development and of the transferring characteristics, the sharpness of the toner image and the gray-level reproducibility improve.

As other alcohol component which may be included in the toner as necessary, for example, diol components having a double bond, diol components having a sulfonic acid group, and so on may be cited. As the diol component having a double bond, for example, 2-butene-1, 4-diols, 3-butene-1, 6-diols, 4-butene-1, 8-diols may be cited. A content of the diol component having a double bond with respect to all alcohol components is preferably 20 mol % or less, and more preferably 2-10 mol %. By allowing the content of the diol component having [symbol] double bond to be 20 mol % or less, the crystalline of the polyester resin to be formed is easily maintained. In addition, since a melting point of the formed polyester resin does not lower so much, filming does not occur.

### 3. Mold Release Agent

The mold release agent whose endothermic peak exists within 85-98° C. is used for the toner of the present invention.

The maximum endothermic peak temperature is measured by differential scanning calorimetry analysis. In the differential scanning calorimetry analysis, 4.5-5.0 mg sample is precisely weighed to two places of decimals and encapsulated in an aluminum sample pan (KITNO. 0129-0041) to be set a sample holder of differential scanning calorimeter DSC-7 (PerkinElmer products). Then temperature control is performed by thermal analysis instrument controller TAC7/DX (PerkinElmer products) at a measurement temperature of 0-200° C., at a rate of temperature increase of 10° C. /minutes, at a rate of temperature decrease of 10° C./minutes, though Heat-Cool-Heat thermal cycle to obtain the maximum endothermic peak temperature based on data measured in second heating cycle.

The mold release agent is not especially limited as long as its maximum endothermic peak temperature is within 85-98° C., and known mold release agent may be used. Specifically, low-molecular-weight polyolefins such as polyethylenes, polypropylenes and polybutenes, plant-based wax such as a synthetic ester waxes, carnauba waxes, rice waxes, candelilla waxes, vegetable waxes and jojoba oils, mineral such as a montan waxes, paraffin waxes, microcrystalline waxes and Fischer-Tropsch waxes, petroleum wax, and their denaturants. Specifically, the paraffin wax (Nippon seiro co., ltd products: HNP0190, melting point of 85° C.) and the Fischer-Tropsch wax (Nippon seiro co., ltd products: FT-100, melting point of 97° C.) are preferably used.

A content of the mold release agent in the toner is preferably 5-20% by weight, and more preferably 7-13% by weight. When the content is less than 5% by weight, sometimes an offset occurs in a high temperature region, and when the content exceeds 20% by weight, the mold release agent tends to hard to be taken into the toner particle. Since the mold release agent which leaves the toner particle or is not taken into the toner particle is easily attached to the surface of the toner particle, there is a possibility that filming characteristics lowers due to influences of this leaving mold release agent and attaching mold release agent.

### 4. Coloring Agents

As the coloring agent, known coloring agent such as carbon blacks, magnetic materials, dye compounds and pigments are arbitrarily used.

As the coloring agent for black, in addition to the carbon black such as furnace blacks, channel blacks, acethylene blacks, thermal blacks and lamp blacks, magnetic power such as magnetites and ferrites may be used.

As the coloring agent for colors, the coloring agents for magenta (or red), yellow (or orange), cyan (or green) and the like may be used, and the pigments and dye compounds which have been conventionally known may be used. As the coloring agents for magenta, pigments such as C.I. pigment red 5, C.I. pigment red 48:1, C.I. pigment red 53:1, C.I. pigment red 57:1, C.I. pigment red 122, C.I. pigment red 139, C.I. pigment red 144, C.I. pigment red 149, C.I. pigment red 166, C.I. pigment red 177, C.I. pigment red 178 and C.I. pigment red 222, or dye compounds such as C.I. solvent red 1, C.I. solvent red 49, C.I. solvent red 52, C.I. solvent red 58, C.I. solvent red 68, C.I. solvent red 11 and C.I. solvent red 122 may be cited. As the coloring agents for yellow, pigments such as C.I. pigment yellow 14, C.I. pigment yellow 17, C.I. pigment yellow 74, C.I. pigment yellow 93, C.I. pigment yellow 94, C.I. pigment yellow 138, C.I. pigment yellow 155, C.I. pigment yellow 180 and C.I. pigment yellow 185, and C.I. pigment orange 31 and C.I. pigment orange 43, or dye compounds such as C.I. solvent yellow 19, C.I. solvent yellow 44, C.I. solvent yellow 77, C.I. solvent yellow 79, C.I. solvent yellow 81, C.I. solvent yellow 82, C.I. solvent yellow 93, C.I. solvent yellow 98, C.I. solvent yellow 103, C.I. solvent yellow 104, C.I. solvent yellow 112 and C.I. solvent yellow 162 may be cited. As the coloring agents for cyan, pigments such as C.I. pigment blue 15;3, C.I. pigment blue 60, C.I. pigment green 7, or dye compounds such as C.I. solvent blue 25, C.I. solvent blue 36, C.I. solvent blue 69, C.I. solvent blue 70, C.I. solvent blue 93 and C.I. solvent blue 95 may be cited. The above pigments and/or dye compounds may be mixed with one another.

### 5. Others

The toner of the present invention may include other agents such as a charge control agent and an external additive as necessary.

As the charge control agent, nigrosine-based dyes, metal salts of naphthene acids or higher fatty acids, alkoxylated amins, quaternary ammonium chlorides, azo-based metal complexes, and salicylic acid metal salts or metal complexes thereof may be cited. The metals to be contained include Al, B, Ti, Fe, Co, Ni and so on. An especially preferable charge control agent is a metal complex component of a benzyl acid derivative.

As the external additive, in addition to known hydrophobic silicas and hydrophobic metal oxides, adding a cerium oxide particle or higher alcohol particle having a carbon number of 20-50 is especially preferable in order to improve anti-filming property. When adding the cerium oxide particle, it is preferable to use the cerium oxide particle whose number mean particle diameter is 150-800 nm in order to improve anti-filming property, and it is more preferable to use the cerium oxide particle whose number mean particle diameter is 250-700 nm. The additive amount of the cerium oxide particle is preferably 0.5-3.5% by weight with respect to the toner. By allowing the additive amount to be 0.5-3.5% by weight, good cleaning property is maintained and an effect of the anti-filming property can be stably obtained. Although adhesive property of the toner particle which melts in heat-fixing is reduced so that a fix level lowers in the case that the additive amount is excessive, by allowing the additive amount to be the above-described range, such problem of fix level reduction does not occur.

When adding the higher alcohol particle having a carbon number of 20-50, an alcohol particle having different carbon number may be mixed in some small measure, but it is preferably that a peak of alcohol particle carbon number distribution exits within 20-45. It is also preferable that straight chain component of the higher alcohol particle is within 75%-98%. The median diameter on number basis of the higher alcohol is preferably from 200 nm or more to 800 nm or less in order to improve anti-filming property.

### <Method for Producing the Toner>

A method for producing the toner of the present invention includes at least the following steps (1) and (2).

(1) A core forming step of agglutinating the following materials i-iv in an aquatic medium to form a core particle

i) the non-crystalline polyester resin including 17-30 mol % of the multivalent calboxylic acid of trivalent or higher-valent with respect to all aid monomers

ii) the crystalline polyester resin particle composed of the straight chain aliphatic diol having a carbon number of 4-22 and the straight chain aliphatic dicarboxylic acid having a carbon number of 4-22

iii) the mold release agent whose maximum endothermic peak temperature exists within 85-98° C.

iv) the coloring agent particle

(2) A shell forming step of adding the non-crystalline polyester resin to form the shell layer of the non-crystalline polyester resin to cover the core particle

In this regard, however, a mass ratio between the non-crystalline polyester resins to be added in the core forming step and in the shell forming step, and the crystalline polyester resin is 90:10-60:40.

Hereinafter a producing method by emulsion association method will be described as an example of the method for producing the toner of the present invention.

### 1. Core Forming Step

A dispersion liquid of the non-crystalline polyester resin including 17-30 mol % of the multivalent carboxylic acid of trivalent or higher-valent with respect to all acid monomers, a dispersion liquid of the crystalline polyester resin including 20-65 mol % straight chain aliphatic diol with respect to all alcohol monomers, a dispersion liquid of the coloring agent, and a dispersion liquid of the mold release agent whose maximum endothermic peak temperature is within 85-98° C. are prepared to be mixed with one another. By adding a flocculant to the mixed dispersion liquid and heating it, the non-crystalline polyester resin particle, the crystalline polyester resin particle, the coloring agent particle and the mold release agent particle are agglutinated in the aquatic medium to fuse with one another to form the core particle. A mass ratio between the additive amount (additive amount obtained by adding the additive amount in the core forming step to the additive amount in the shell forming step) of the non-crystalline polyester resin and the additive amount of the crystalline polyester resin is 90:10-60:40.

### 2. Shell Forming Step

When the particle diameter of the core particle formed by agglutination approximately reaches 80% or more of a desired toner particle diameter, the dispersion liquid of the non-crystalline polyester resin particle is added. The additive amount of the non-crystalline polyester resin to be used in the shell layer is 10-40% by weight with respect to the sum of the additive amounts of non-crystalline polyester resin and crystalline polyester resin which are used in the core particle. By this, the non-crystalline polyester resin particles are adhered to the surface of the core particle so that the shell layer is formed.

When forming the shell layer, it is preferable to allow the resin particle for shell to adhere to the core layer by salting out, and to fuse with each other by heat energy. A salting-out agent may be added after input of the dispersion liquid of the resin particle for shell, but in order to cover the core particle with the shell layer uniformly, it is preferable that the salting-out agent exists in the aquatic medium before the input. As the salting-out agent, univalent metal salts such as lithiums, potassiums and sodiums, and divalent metal salts such as magnesiums, calciums, strontiums and bariums may be cited.

### 3. Solid-Liquid Separating and Drying Step

The dispersion liquid of the toner particle is cooled and subjected to solid-liquid separation to obtain a toner cake (toner formed into a cake-like shape in the wet state). Then, the toner cake is repeatedly subjected to cleaning processing and filtration processing to remove extraneous matters such as surface-acting agents and salting-out agents therefrom. As the filtration processing, a centrifugal separation method, a vacuum filtration method using Nutsche, filtration method using filter press and the like may be cited, but the processing is not especially limited.

When the cleaning processing ends, drying processing is performed. As a drying machine to be used in the drying processing, a spray dryer, vacuum freeze dryer, and pressure reduction drying machine may be cited.

### 4. External Application Processing Step

When adding the external additive, an external application processing is performed. The external application processing may be performed by using known mixing apparatus such as V-blender, Henschel mixer, Loedige mixer, and it is possible to allow the external additive to the surfaces of the toner particles in a phased manner.

### <Production of Developer>

When using the toner of the present invention as two-component developer to be mixed with a carrier, it is possible to inhibit an occurrence of toner filming (carrier contamination) with respect to the carrier. When using the toner of the present invention as one-component developer including magnetic material, it is possible to inhibit an occurrence of toner filming with respect to a friction-charged member of the developer.

As the carrier constituting the two-component developer, metals such as iron, ferrite and magnetite, mixed metal of these metals and metals such as aluminum and lead, and magnetic particles composed of known material may be used, and especially a ferrite particle is preferably used.

As the carrier, a carrier whose volume mean particle diameter is 15-100 μm is preferably used, and a carrier whose volume mean particle diameter is 25-60 μm is more preferably used. The volume mean particle diameter of the carrier may be measured by a laser diffraction particle diameter distribution analyzer, HELOS (SYMPATEC products), equipped with a wet-type disperser.

It is preferable to use, as the carrier, a carrier which is further covered by resin, or a magnetic particle-dispersed carrier in which magnetic particle is dispersed in resin. Although a resin composition for covering is not especially limited, olefin resins, styrene resins, styrene-acrylic resin, silicon resin, ester resin, fluorine-containing polymer resins or the like are used, for example. The resin constituting the resin-dispersed carrier is not especially limited, and known resins may be used. For example, styrene-acrylic resins, polyester resins, fluorine resins, phenol resins or the like may be used.

### Examples

In the following, concrete examples of the present invention will be described. The present invention is not limited to the examples.

### 1. Preparation of Dispersion Liquid

### (1) Preparation of Dispersion Liquid 1 of Non-Crystalline Polyester Resin

The following monomers and 0.12 parts dibutyltin oxide as the catalyser were put in a heat-dried three neck flask, and then the pressure of the air in the container was reduced by pressure reduction operation, and an inert atmosphere was created by nitrogen gas and reflux processing was performed by stirring with machine at 180° C. for 6 hours. After that, stirring processing was performed for 5 hours while the temperature was gradually raised to 200° C. by distillation under reduced pressure, and the distillation under reduced pressure was stopped and air-cooling was performed to obtain the non-crystalline polyester resin 1.

### (Monomers)

Bisphenol A propylene oxide adduct (average number of added moles: one (1), molecular weight: 392): 63.2 parts by mass

Terephthalic acid (molecular weight: 166) 26.8 parts by mass

Next, the non-crystalline polyester resin 1 was transferred to “CAVITRON CD1010” (Eurotec products) at the speed of 100 g per minutes while maintaining its melt state. On the other hand, a diluted ammonia water which was prepared to have a concentration of 0.37% by weight by diluting reagent ammonia solution with ion-exchange water was input in an aquatic medium tank separately prepared, and heated to 120° C. by a heat exchanger. Then, the heated diluted ammonia water was transferred to the CAVITRON CD1010 at the same time as the non-crystalline polyester resin 1. A rate of transfer was 0.1 liters per minutes. In this state, by setting a rotation frequency of a rotator to 60 Hz (3600 r.p.m, a peripheral speed of the rotator was 12.9 m/s) and setting a pressure to 4.9×10⁵ Pa to drive the CAVITRON CD1010, the dispersion liquid 1 of the non-crystalline polyester resin whose median diameter on volume basis was 0.26 μm was produced. After that, a water amount of the dispersion liquid was adjusted so that the concentration of the resin particle became 20% by weight.

### (2) Preparation of Dispersion Liquid 2 of the Non-Crystalline Polyester Resin

The dispersion liquid 2 of the non-crystalline polyester resin whose median diameter on volume basis was 0.14 μm was produced by a similar procedure to the above except the point that the monomers used in preparation of dispersion liquid 1 of the non-crystalline polyester resin was replaced by the following monomers.

### (Monomers)

Bisphenol A propylene oxide adduct (average number of added moles: one (1)): 62.2 parts by mass

Terephthalic acid: 21.1 parts by mass

Trimellitic acid (molecular weight: 210): 6.7 parts by mass

### (3) Preparation of Dispersion Liquids 3-6 of the Non-Crystalline Polyester Resin

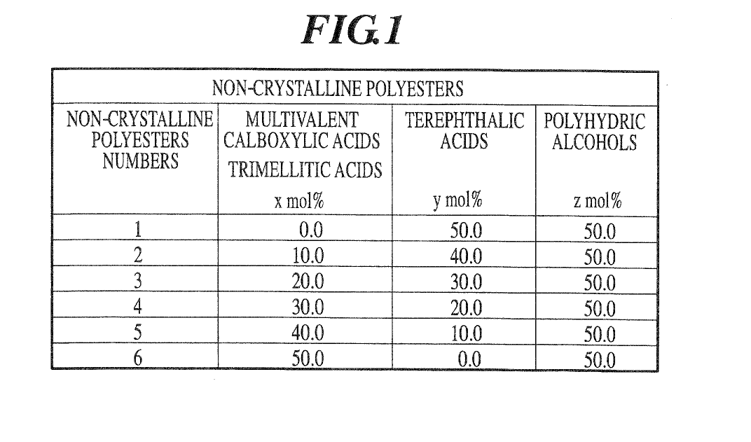

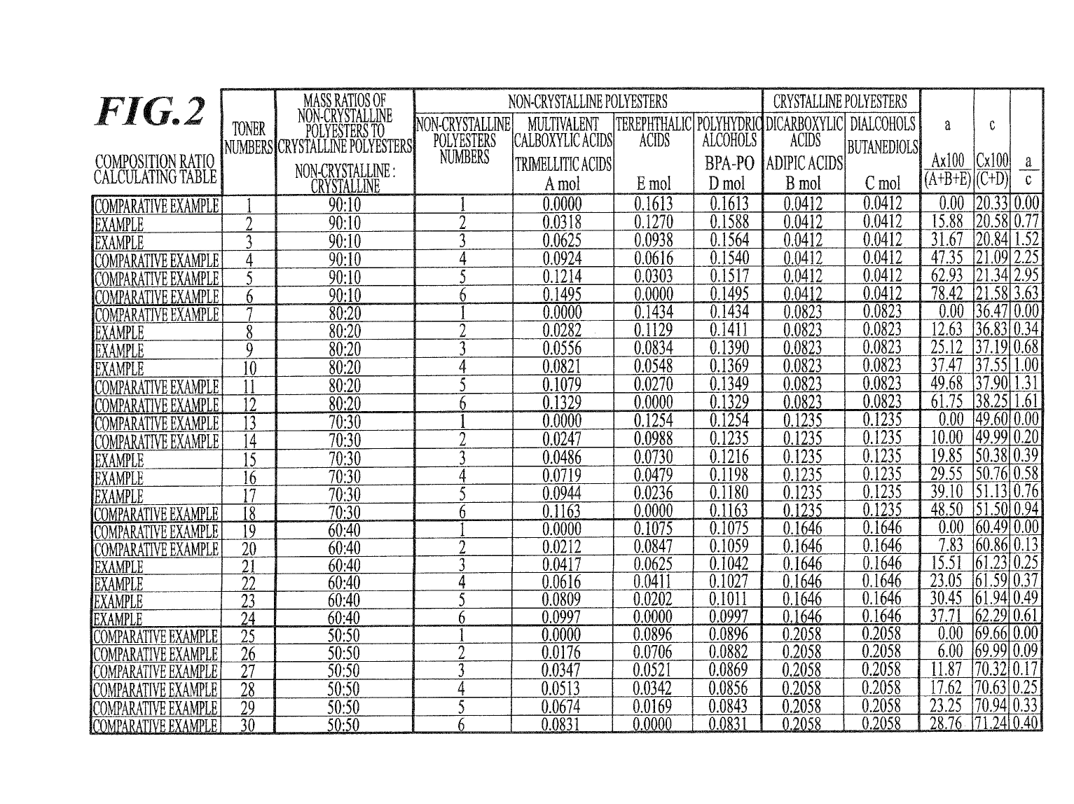

The dispersion liquids 3-6 of the non-crystalline polyester resins were produced by a similar procedure to the above except the point that the monomers used in preparation of dispersion liquid 2 of the non-crystalline polyester resin was replaced by the monomers of compositions shown in FIGS. 1 and 2. A median diameter on volume basis of the dispersion liquids 3-6 of the non-crystalline polyester resins can be controlled to 0.12-0.16. FIGS. 1 and 2 show lists of the multivalent calboxylic acids and the polyhydric alcohols which are monomers used in preparation of the dispersion liquids 1-6 of the non-crystalline polyester resins. FIG. 1 shows an additive amount (mol %) (ratio in all monomers constituting non-crystalline polyester) of each monomer, and FIG. 2 shows an additive amount (mol) of each monomer.

BPA-PO in FIGS. 1 and 2 means Bisphenol A propylene oxide adduct (average number of added moles: one (1)).

### (4) Preparation of Dispersion Liquid 1 of the Crystalline Polyester Resin

The monomers of the following composition were put in a heat-dried three neck flask. In addition, tetrabutoxy titan (Ti (OBU)₄) of 0.014% by weight with respect to sebacic acid was input as the catalyser. Then the pressure of the air in the flask container was reduced by pressure reduction operation, and an inert atmosphere was created by nitrogen gas and reflux processing was performed by stirring with machine at 180° C. for 5 hours. After that, stirring processing was performed for 3 hours while the temperature was gradually raised to 200° C. by distillation under reduced pressure, and the distillation under reduced pressure was stopped at the time when the object becomes viscous and air-cooling was performed to produce the non-crystalline polyester resin 1.

### <Monomers>

Adipic acid (molecular weight: 416): 6.0 parts by mass

b 1,4-butanediol (molecular weight: 97): 4.0 parts by mass

Next, the non-crystalline polyester resin 1 was transferred to the CAVITRON CD1010 at the speed of 100 g per minutes while maintaining its melt state. Moreover, the diluted ammonia water which was prepared to have a concentration of 0.37% by weight by diluting reagent ammonia solution with ion-exchange water was input in an aquatic medium tank separately prepared, and heated to 120° C. by a heat exchanger. Then, the heated diluted ammonia water was transferred to the CAVITRON CD1010 at the speed of 0.1 liters per minutes at the same time as a melt of the crystalline polyester resin 1. In this state, by setting a rotation frequency of a rotator to 60 Hz (3600 r.p.m, peripheral speed of the rotator is 12.9 m/s) and setting a pressure to 4.9×10⁵ Pa to drive the CAVITRON CD1010, the dispersion liquid 1 of the crystalline polyester resin was produced. The median diameter on volume basis of the crystalline polyester resin 1 was 0.26 μm. In addition, a water amount of the dispersion liquid was adjusted so that the concentration of the resin particle became 20% by weight.

### (5) Preparation of Dispersion Liquids 2-5 of the Crystalline Polyester Resin

The dispersion liquids 2-5 of the crystalline polyester resins were produced by a similar procedure to that of the dispersion liquid 1 of the crystalline polyester resin except the point that the monomers used in preparation of dispersion liquid 1 of the crystalline polyester resin was replaced by the monomers of compositions shown in FIG. 2. As shown in FIG. 2, the dispersion liquid 1 of the crystalline polyester resin had a composition of 0.0412 mol adipic acid and 0.0412 mol butanediol, and the dispersion liquids 2-5 of the crystalline polyester resins had compositions in which the number of moles of the adipic acid and the butanediol increases in sequence. FIG. 2 shows a list of the multivalent carboxylic acids and the straight chain aliphatic diols which are monomers used in preparation of the dispersion liquids 1-5 of the crystalline polyester resins. In the list, an additive amount of each monomer (mol) is shown. The median diameters on volume basis of the dispersion liquids 2-5 of the crystalline polyester resin were 0.24 μm, 0.22 μm, 0.23 μm and 0.23 μm respectively.

FIG. 2 also shows each ratio a of the carboxylic acids of trivalent or higher-valent constituting the polyester resin (including both of the non-crystalline and crystalline polyester resins) of the toner with respect to all acid monomers, each ratio c of the straight chain aliphatic diol to all alcohol monomers, each ratio “a/c”, each average value e of degree of circularity of the toner particle, and each median diameter on volume basis.

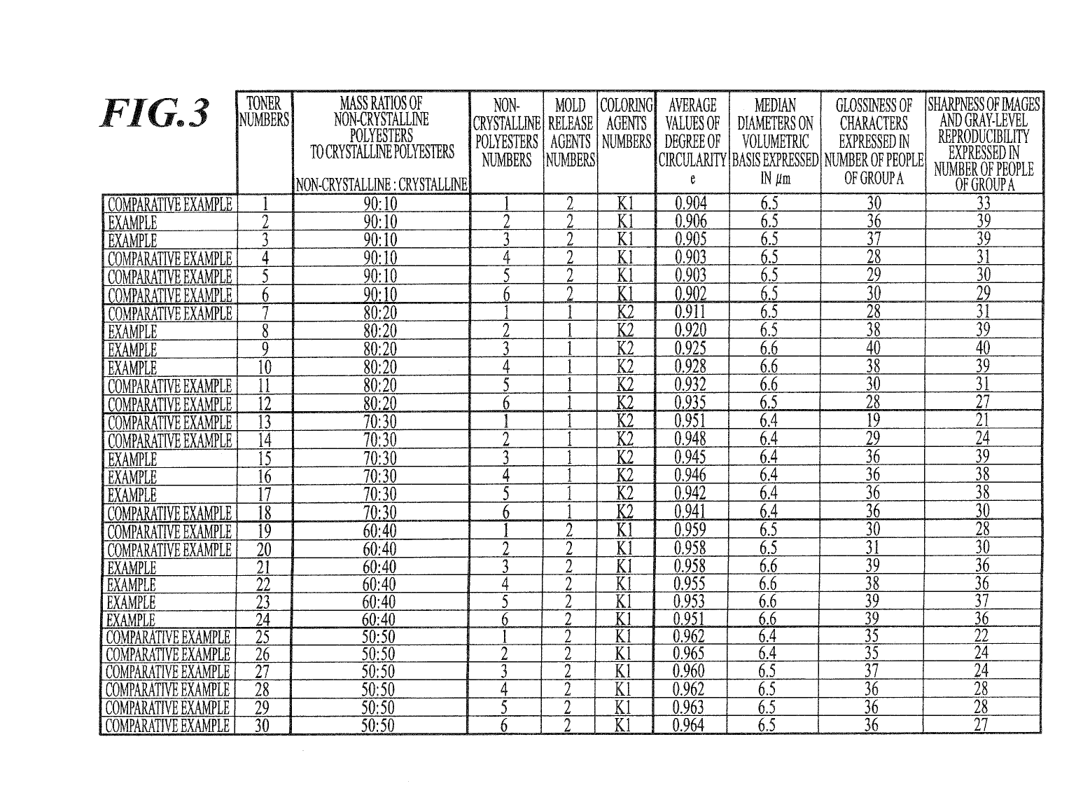

The ratio a is represented by the following formula when the multivalent carboxylic acid of trivalent or higher-valent used in the non-crystalline polyester resin is allowed to be A mol and the multivalent carboxylic acid of lower-valent than trivalent is allowed to be E mol as shown FIGS. 1 and 2, and when the multivalent carboxylic acid of lower-valent than trivalent is allowed to be B mol as shown in FIG. 3.

a=A/(A+B+E)×100

The ratio c is represented by the following formula when the polyhydric alcohol used in the non-crystalline polyester resin is allowed to be D mol as shown in FIGS. 1 and 2, and when the straight chain aliphatic diol used in the crystalline polyester resin is allowed to be C mol as shown in FIG. 3.

c=C/(C+D)×100

### (6) Preparation of Dispersion Liquid K1 of the Coloring Agent

Carbon black “REGAL330 (CABOT products)”: 40 parts by mass

C.I. pigment blue 15:3: 10 parts by mass

Ionic surface active agent (n-dodecylbenzenesulfonic acid sodium salt): 8 parts by mass

Ion-exchange water: 250 parts by mass

These components were mixed and melt to be subjected to dispersion processing by ULTRA TURRAX T50 HOMOGENIZER (IKA products) for 10 minutes, and then they were processed by an ultrasonic disperser for 10 minutes to prepare the dispersion liquid K1 of the coloring agent for black where the coloring agent particle whose median diameter on volume basis was 286 nm was dispersed.

### (7) Preparation of Dispersion Liquid K2 of the Coloring Agent

Carbon black “REGAL330 (CABOT products)”: 50 parts by mass

Ionic surface active agent (n-dodecylbenzenesulfonic acid sodium salt): 8 parts by mass

Ion-exchange water: 250 parts by mass

These components were mixed and melt to be subjected to dispersion processing by the ULTRA TURRAX T50 for 10 minutes, and then they were processed by an ultrasonic disperser for 10 minutes to prepare the dispersion liquid K2 of the coloring agent for black where the coloring agent particle whose median diameter on volume basis was 278 nm was dispersed.

### (8) Preparation of Dispersion Liquid 1 of the Mold Release Agent

Paraffin wax “FNP0090 (Nippon seiro co., ltd products)” (maximum endothermic peak temperature: 90.2° C.) 10 parts by mass

Pentaerythritol tetrabehenate: 50 parts by mass

Ionic surface active agent (n-dodecylbenzenesulfonic acid sodium salt): 5 parts by mass

Ion-exchange water: 200 parts by mass

The liquid obtained by mixing and melting these components was heated to 95° C., subjected to dispersion processing by the ULTRA TURRAX T50 for 10 minutes, and then subjected to dispersion processing by pressure discharge type Gaulin homogenizer to obtain the dispersion liquid 1 of the mold release agent. The solid content of the dispersion liquid 1 of the mold release agent was 20% by mass, and the median diameter on volume basis of the mold release agent particle was 220 nm.

### (9) Preparation of Dispersion Liquid 2 of the Mold Release Agent

The dispersion liquid 2 of the mold release agent whose median diameter on volume basis was 210 nm and whose solid content was 20% by mass was prepared by a similar procedure to that of the dispersion liquid 1 of the mold release agent except the point that the Paraffin wax FNP0090 used in preparation of the dispersion liquid 1 of the mold release agent was replaced by a Fischer-Tropsch wax FT-100 (Nippon seiro co., ltd products, maximum endothermic peak temperature: 97° C.).

### 2. Production of the Toner

### (1) Production of Toner 1

Dispersion liquid 1 of the non-crystalline polyester resin 1: 80 parts by mass

Dispersion liquid 1 of the crystalline polyester resin 1: 10 parts by mass

Dispersion liquid K1 of the coloring agent: 10 parts by mass

Dispersion liquid 2 of the mold release agent: 12.5 parts by mass

These components were put into a round stainless steel flask, and prepared so as to be 20° C. while being stirred with ion-exchange water of 37.5 parts by mass. After that, dispersion liquid was prepared by fully mixing with the ULTRA TURRAX T50 and performing dispersion processing. Next, polyaluminum chloride of 0.1 parts by mass was added to the dispersion liquid, and the dispersion processing by the ULTRA TURRAX T50 was continued. After the dispersion processing, the flask was put into an oil bath, and heated to 45° C. while being stirred. After maintaining the flask at 45° C. for 60 minutes, the dispersion liquid 1 of crystalline polyester resin of 10 parts was slowly added as the resin particle for shell in the dispersion liquid. A mass ratio between the added dispersion liquid 1 of the non-crystalline polyester resin (additive amounts of both for core and for shell) and the dispersion liquid 1 of the crystalline polyester resin was 90:10.

In addition, ethylenediaminetetraacetic acid tetrasodium salt tetrahydrate of one (1) percent of dispersion liquid solid content was added, and pH of the system was adjusted to 8 by aqueous sodium hydroxide of 0.5 mol/liter. Next, it was heated to 90° C. while sealing the stainless steel flask and continuing stirring by using magnetic seal, and pH of the system was adjusted to 7 by using nitric acid of 0.5 mol/liter and maintained for 30 minutes to continue the reaction.

After the reaction, the object was rapidly cooled to 30° C. by using a tubular heat exchanger (cooling medium is cold water of 5° C.) while adjusting flow volume of the cold water so that a cooling rate becomes −25° C/minutes. After rapid cooling, the object was subjected to filtration processing and fully washed with ion-exchange water, and then solid-liquid separation was performed by Nutsche suction filtration. In addition, the separated particles were re-dispersed in ion-exchange water of 3 liter at 43° C., and subjected to washing processing by being stirred at 300 rpm for 15 minutes.

This operation was repeated 5 times, and at the time when pH of filtrate became 6.6 and electric conductivity became 12 μS/cm, solid-liquid separation was performed using No. 5A filter paper by Nutsche suction filtration.

Next, vacuum drying was continued for 12 hours, and dried powder was subjected to external additive processing. In the external additive processing, the following components were added to the dried powder of 100 parts by mass, and mixed for 10 minutes by 5-liter Henschel mixer (Mitsui Miike Engineering co., ltd product).

Cerium oxide particle (primary particle diameter: 350 nm): 2.5 parts by mass

Titania particle (dodecyltrimethoxysilane-processed, median diameter on volume basis: 30 nm): 0.8 parts by mass

Silica particle (hexamethyldisilazane-processed, median diameter on volume basis: 10 nm): 1.2 parts by mass

Moreover, the object was subjected to sieving processing by wind-driven sieving machine having 45 μm opening size to obtain toner 1. A median diameter on volume basis of the toner 1 was 6.5 μm, and an average value e of degree of circularity was 0.904.

### (2) Production of Toners 2-6

The toners 2-6 were obtained by a similar method procedure to that of the toner 1 except the point that each of the dispersion liquids 2-6 of the non-crystalline polyester resins was used instead of the dispersion liquid 1 of the non-crystalline polyester resin. FIG. 3 shows each median diameter on volume basis and average value e of degree of circularity of the obtained toners 2-6. FIG. 3 also shows, with respect to the toners 1-30 of the examples and the comparative examples, numbers of the dispersion liquids of non-crystalline polyester resins which were used in toner production, mass ratios between the dispersion liquids of non-crystalline polyester resins and the dispersion liquids of crystalline polyester resins, numbers of the mold release agents, numbers of the coloring agents, and evaluation results described below.

### (3) Production of Toner 7

The toner 7 was produced by a similar method procedure to that of the toner 1 except the point that the following materials were used in stead of the dispersion liquid 1 of the non-crystalline polyester resin for core, the dispersion liquid 1 of the crystalline polyester resin, the dispersion liquid K1 of the coloring agent, and the dispersion liquid 2 of the mold release agent, and except the point that the dispersion liquid 1 of the non-crystalline polyester resin for shell was replaced by the non-crystalline polyester resin 7.

Dispersion liquid 7 of the non-crystalline polyester resin 7: 70 parts by mass

Dispersion liquid 2 of the crystalline polyester resin 2: 20 parts by mass

Dispersion liquid K2 of the coloring agent: 10 parts by mass

Dispersion liquid 1 of the mold release agent: 12.5 parts by mass

A mass ratio between the dispersion liquid 7 of the non-crystalline polyester resin used in preparation of the toner 7 and the dispersion liquid 2 of the crystalline polyester resin was 80:20.

### (4) Production of Toners 8-12

The toners 8-12 were obtained by a similar method procedure to that of the toner 7 except the point that each of the dispersion liquids 8-12 of the non-crystalline polyester resin was used in stead of the dispersion liquids 7 of the non-crystalline polyester resins for core and for shell.

FIG. 3 shows the median diameters on volume basis and average values e of degree of circularity of the toners 7-12.

### (5) Production of Toner 13

The toner 13 was obtained by a similar method procedure to that of the toner 1 except the point that the following materials were used in stead of the dispersion liquid 1 of the non-crystalline polyester resin for core, the dispersion liquid 1 of the crystalline polyester resin, the dispersion liquid K1 of the coloring agent and the dispersion liquid 2 of the mold release agent, and except the point that the dispersion liquid 1 of the non-crystalline polyester resin for shell was displaced by the non-crystalline polyester resin 13.

Dispersion liquid 13 of the non-crystalline polyester resin 13: 60 parts by mass

Dispersion liquid 3 of the crystalline polyester resin 3: 30 parts by mass

Dispersion liquid K2 of the coloring agent: 10 parts by mass

Dispersion liquid 1 of the mold release agent: 12.5 parts by mass

A mass ratio between the dispersion liquid 7 (additive amount of both for core and for shell) of the non-crystalline polyester resin and the dispersion liquid 2 of the crystalline polyester resin was 70:30.

### (6) Production of Toners 14-18

The toners 14-18 were produced by a similar method procedure to that of the toner 13 except the point that each of the non-crystalline polyester resins 14-18 was used in stead of the non-crystalline polyester resin 13.

FIG. 3 shows the median diameters on volume basis and average values e of degree of circularity of the toners 13-18.

### (7) Production of Toner 19

The toner 19 was produced by a similar method procedure to that of the toner 1 except the point that the following materials were used in stead of the dispersion liquid 1 of the non-crystalline polyester resin for core and the dispersion liquid 1 of the crystalline polyester resin, and except the point that the dispersion liquid 19 of the non-crystalline polyester resin was used instead of the dispersion liquid 1 of the non-crystalline polyester resin for shell.

Dispersion liquid 19 of the non-crystalline polyester resin: 50 parts by mass

Dispersion liquid 4 of crystalline polyester resin: 40 parts by mass

A mass ratio between the dispersion liquid 19 (additive amount of both for core and for shell) of the non-crystalline polyester resin and the dispersion liquid 4 of the crystalline polyester resin was 60:40.

### (8) Production of Toners 20-24

The toners 20-24 were produced by a similar method procedure to that of the toner 19 except the point that each of the non-crystalline polyester resins 20-24 was used in stead of the dispersion liquids 19 of the non-crystalline polyester resins for core and for shell.

FIG. 3 shows the median diameters on volume basis and average values e of degree of circularity of the toners 20-24.

### (9) Production of Toner 25

The toner 25 was produced by a similar method procedure to that of the toner 1 except the point that the following materials were used in stead of the dispersion liquid 1 of the non-crystalline polyester resin for core and the dispersion liquid 1 of the crystalline polyester resin, and except the point that the dispersion liquid 25 of the non-crystalline polyester resin was used in stead of the dispersion liquid 1 of the non-crystalline polyester resin for shell.

Dispersion liquid 25 of the non-crystalline polyester resin: 40 parts by mass

Dispersion liquid 5 of the crystalline polyester resin: 50 parts by mass

### (10) Production of Toners 26-30

The toners 26-30 were produced in a similar method procedure to that of the toner 25 except the point that each of the non-crystalline polyester resins 26-30 was used in stead of the dispersion liquids 25 of the non-crystalline polyester resins for core and for shell.

FIG. 3 shows the median diameters on volume basis and average values e of degree of circularity of the toners 25-30.

### (11) Preparation of the Developer

Next, in order to prepare the developer, Silicone Resin SR2411 (Dow Corning Toray co., ltd products) of 0.8% by mass with respect to a ferrite core having 45 μm particle diameter was added to obtain a coating carrier by using a fluidized bed coating apparatus. This carrier of 94 parts by mass and each of the produced toners 1-30 of 6 parts by mass were mixed to each other by V-type blender to prepare the developers of the toners 1-30.

### 3. Evaluation Experiment

The developer of each of the toners 1-30 was set in a commercial full color printer bizhub PRO 950 (Konica Minolta Business Technologies co., ltd products) to perform each evaluation experiment of the following items.

### (1) Glossiness of Characters

10 point characters were printed on both sides of A4-size sheet. 40 panelists deciphered character images formed on the sheet with toner under light of a fluorescent table lamp of 40 W in a darkened room, and the panelists were divided into the following two groups depending on a deciphered result.

Group A: people who could ignore glossiness of characters so that deciphering was not interfered by the glossiness

Group B: people who could not ignore the glossiness and adjusted an angle of the sheet or the table lamp for deciphering

The toner for which the number of people of Group A was 34 or more was evaluated as acceptable level toner.

### (2) Sharpness of an Image and Gray-Level Reproducibility

Test chart (test chart No. 4, the Imaging Society of Japan) of the following 1201, 2001 were printed on both sides of A4-size sheet.

1201: patch images in concentrations of 10%, 20% and 30%

2001: patch images in concentrations of 10%, 20% and 30%.

40 panelists deciphered character images formed on the sheet with toner under light of a fluorescent table lamp of 40 W in a darkened room, and the panelists were divided into the following two groups depending on a deciphered result.

Group A: people who did not find non-uniformity such as uneven concentration in the patch images of 1201, 2001 so that the patch image of 2001 seems to have higher definition than the patch image of 1201

Group B: people who detected non-uniformity due to uneven concentration in any of the patch images of 1201, 2001 so that a difference of definitions between the patch image of 1201 and the patch image of 2001 cannot be detected

The toner for which the number of people of Group A was 34 or more was evaluated as acceptable level toner.

### 4. Evaluation Results

FIG. 3 shows evaluation results of the evaluation experiments.

As shown in FIG. 3, the toners 2, 3, 8-10, 15-17 and 21-24 of the examples had no excessive glossiness and were at an acceptable level where characters can be easily read. The sharpness of images and the gray-level reproducibility were also high. On the other hand, the toners 1, 4-7, 11-14, 18, 19, 20 and 25-30 of the comparative examples had excessive glossiness so that characters were hard to be deciphered. Moreover, uneven concentration occurred, and the sharpness of images and the gray-level reproducibility lowered.

All of the disclosures including the claims, the patent specification, the attached drawings and the abstract of Japanese Patent Application No. 2009-111714 filed on May 1, 2009 are herein incorporated by reference.

Although various typical embodiments have been shown and described, the present invention is not limited to those embodiments. Consequently, the scope of the present invention can be limited only by the following claims.

What is claimed is:

1. A toner comprising:
a toner particle including at least a resin, a coloring agent and a mold release agent,
wherein an average value e of degree of circularity of the toner particle is within 0.935≦e≦0.982,
a maximum endothermic peak temperature of the mold release agent exists within 85-98° C.,
the resin includes at least non-crystalline polyester and crystalline polyester, and
a ratio a of multivalent calboxylic acid of trivalent or higher-valent and a ratio c of straight chain aliphatic diol are such that
12.5≦a≦46
20≦c≦65
0.25≦a/c≦1.52,
the multivalent calboxylic acid of trivalent or higher-valent and/or the straight chain aliphatic diol constituting the non-crystalline polyester and/or the crystalline polyester.

2. The toner of claim 1, wherein the ratio a of the multivalent calboxylic acid of trivalent or higher-valent and the ratio c of the straight chain aliphatic diol are such that
23≦a≦39
20.8≦c≦52.0
0.37≦a/c≦0.80.

3. A method for producing a toner including at least a non-crystalline polyester resin, a crystalline polyester resin, a coloring agent and a mold release agent, the method comprising the steps of:
(1) forming a core particle by agglutinating materials of:
i) a non-crystalline polyester resin particle including the multivalent calboxylic acid of trivalent or higher-valent of 17-30 mol % with respect to all acid monomers;
ii) a crystalline polyester resin particle composed of straight chain aliphatic diol having a carbon number of 4-22 and straight chain aliphatic dicarboxylic acid having a carbon number of 4-22;
iii) a mold release agent particle whose maximum endothermic peak temperature exists within 85-98° C.; and
iv) a coloring agent particle, and
(2) adding the non-crystalline polyester resin particle to form a shell layer of the non-crystalline polyester resin to cover the core particle,
provided that a mass ratio between a sum of the non-crystalline polyester resins added in the step (1) and the step (2), and the crystalline polyester resin is within 90:10-60:40.
